(19) United States
(12) Patent Application Publication
(10) Pub. No.: US 2010/0007162 A1
(43) Pub. Date: Jan. 14, 2010

(54) APPARATUS AND METHOD FOR MANUFACTURING SUPER HIGH FLUIDITY URETHANE-BASED SPHERICAL FINE POWDER

(75) Inventors: In Soo Han, Gyeonggi-do (KR); Kie Youn Jeong, Gyeonggi-do (KR); Sung Min Cho, Daejeon (KR)

Correspondence Address: EDWARDS ANGELL PALMER & DODGE LLP, P.O. BOX 55874, BOSTON, MA, 02205, US

(73) Assignees: HYUNDAI MOTOR COMPANY, Seoul (KR); KIA MOTORS CORPORATION, Seoul (KR)

(21) Appl. No.: 12/352,675

(22) Filed: Jan. 13, 2009

(30) Foreign Application Priority Data
Jul. 14, 2008 (KR) 10-2008-0068027

(51) Int. Cl. B62D 29/00; B29B 9/10

(52) U.S. Cl. 296/1.01; 425/6; 264/8

(57) ABSTRACT

The present invention provides an apparatus and method for manufacturing super high fluidity urethane-based spherical fine powder for powder slush molding by melting and mixing a super high fluidity urethane-based thermoplastic resin at high temperature, passing the thermoplastic resin through micro-sized fine holes to be extruded into a fine diameter, cutting the extruded thermoplastic resin into spherical fine powder having a uniform particle size, and drying the cut spherical fine powder.

### CROSS-REFERENCE TO RELATED APPLICATION

This application claims under 35 U.S.C. §119(a) the benefit of Korean Patent Application No. 10-2008-0068027 filed Jul. 14, 2008, the entire contents of which are incorporated herein by reference.

### BACKGROUND

(a) Technical Field

The present invention relates to an apparatus and method for manufacturing super high fluidity urethane-based spherical fine powder. More particularly, the present invention relates to an apparatus and method for manufacturing spherical fine powder for powder slush molding by melting and mixing a super high fluidity urethane-based thermoplastic resin at high temperature, passing the thermoplastic resin through micro-sized fine holes to be extruded into a fine diameter, cutting the extruded thermoplastic resin into spherical fine powder having a uniform particle size, and drying the cut spherical fine powder.

(b) Background Art

An instrument panel for a vehicle is a kind of decoration pad, preferably including an installation area in which a dashboard, an air back, a glove box, etc. are installed. For example, in luxury vehicles, the surface material of the instrument panel is generally formed of powder slush to offer a luxury feel.

That is, the surface material of the instrument panel for a luxury vehicle is preferably formed by a powder slush molding process, in which powder for forming the surface material is put into a powder supply box and, then, a heated mold is suitably placed thereon and rotated such that the powder being in contact with the heated mold is molten and, at the same time, formed into a suitably sheet-like shape in accordance with the shape of the mold surface.

Conventionally, in manufacturing the surface material, a polyvinyl chloride powder molding composition preferably including a plasticizer has been used for a long time; however, the polyvinyl chloride composition forms acidic materials during waste incineration, the surface material is reflected in the front window glass of the vehicle to make a driver's eyesight dim, and, as such, it is difficult to apply a transparent back to a passenger seat due to its suitably poor low-temperature impact properties.

Accordingly, in order to address the above-described problems of the polyvinyl chloride composition, a powder material for powder slush molding, which is prepared by freeze-crushing an olefin-based or urethane-based thermoplastic elastomer resin and a polyurethane elastomer resin, is used, as described in Japanese Patent Publication Nos. 1991-199579 and 1991-199589, incorporated by reference in their entireties herein.

The cost of the freeze-crushing process for forming powder is considerably high, which results in an increase in manufacturing cost. Moreover, since the particle size distribution is not uniform and it contains a considerable number of fine particles, the particle fluidity is reduced and, thus, if left alone for a long time, powder particles are suitably bonded to each other, which results in a reduction in the particle fluidity, which is required for the powder slush molding process. As a result, the rear surface is not smoothly molten or pin holes are formed.

Accordingly, in terms of the characteristics of the powder slush molding process, in a case where a winding product or a product having a complicated shape is suitably molded using a composition having excellent melting characteristics, in order to produce a normal product having enhanced appearance and molded state, it is necessary that the thermoplastic elastomer powder preferably is molten and coated on the surface of the mold heated to a molding temperature in a constant thickness and is readily filled throughout the mold.

Otherwise, there are problems in that small pinholes or large holes are formed on the molded product or the molten state of the rear surface and the surface roughness are suitably reduced.

Accordingly, with the repetition of the powder slush molding process, the powder being that is contact with the heated mold is suitably molded into the sheet (e.g. the surface material); however, since the powder not being in contact with the mold accumulates heat in the powder supply box for a considerable amount of time, the powder is partially molten and thereby suitably lumped or adhered to the inner wall of the powder supply box. Accordingly, since the lump powder comes in contact with the mold surface during molding, pinholes are formed, surface defects occur, and, accordingly, the powder is not filled in the angled portions.

Accordingly, it is necessary to suitably manufacture powder without a freeze-crushing process and improve the fluidity of the thus manufactured powder.

Moreover, in order to reduce the manufacturing cost and the high defect rate caused by the above problems, it is necessary to develop a method for manufacturing powder having a uniform particle distribution and improved fluidity.

An apparatus and method for manufacturing spherical fine powder for powder slush molding, used as a vehicle instrument surface material, using olefin-based and urethane-based thermoplastic elastomer resin is described by Korean Patent Application No. 10-2007-0063389, incorporated by reference in its entirety herein.

The manufacturing cost of the olefin-based resin is suitably increased by an increase in coating cost and a reduction in mold life, and, accordingly, the cost burden of vehicle manufacturing companies and molding companies is increased. Preferably, the powder slush molding material used as the vehicle instrument surface material is changed to urethane-based materials and, as an exemplary urethane based material, the urethane-based material that is used is a super high fluidity urethane-based material, in which the fluidity is considerably increased to reduce the defect rate and improve the productivity. Accordingly, it is preferable to provide a method for manufacturing spherical fine powder using the same.

The above information disclosed in this Background section is only for enhancement of understanding of the background of the invention and therefore it may contain information that does not form the prior art that is already known in this country to a person of ordinary skill in the art.

### SUMMARY OF THE DISCLOSURE

The present invention provides an apparatus and method for manufacturing high fluidity or super high fluidity urethane-based spherical fine powder. The urethane-based spherical fine powder as described herein addresses the conventional problems such as high manufacturing cost during freeze-crushing, and rear surface defects and pinhole formation caused by the non-uniformity of particle size distribution. In preferred embodiments, the present invention provides an apparatus and method for manufacturing spherical fine powder for powder slush molding by suitably melting and mixing a high fluidity or super high fluidity urethane-based thermoplastic resin at high temperature, passing the thermoplastic resin through micro-sized fine holes to be extruded into a fine diameter, cutting the extruded thermoplastic resin into spherical fine powder having a uniform particle size, and drying the cut spherical fine powder.

In preferred embodiments, the present invention provides an apparatus for manufacturing super high fluidity urethane-based spherical fine powder, the apparatus preferably comprising: an extruder for melting and mixing a super high fluidity urethane-based thermoplastic resin; a gear pump for suitably transferring the thermoplastic resin, extruded from the extruder, by a predetermined amount; a fine extrusion die preferably including fine holes for extruding the thermoplastic resin, transferred through the gear pump, into a fine diameter, and a suitable cutting means for cutting the thermoplastic resin, extruded from the fine holes, into spherical fine powder in a underwater way; a coolant tank for supplying coolant; a suitable heat exchanger for controlling the temperature of the coolant to a predetermined level; a transfer line, connected between the fine extrusion die and a centrifugal separator, through which the spherical fine powder, cut by the cutting means, is transferred together with the coolant; the centrifugal separator for separating the spherical fine powder and the coolant from each other, transferred through the transfer line; a coolant return line suitably connected between the centrifugal separator and the coolant tank and collecting the coolant; a discharge line connected to the centrifugal separator and discharging the spherical fine powder; and a dehumidifying dryer connected to the discharge line and drying the spherical fine powder discharged through the discharge line.

In a preferred embodiment, the extruder is one selected from the group consisting of, but not limited to, a single-screw extruder, a twin-screw extruder, and a Banbury mixer.

In another preferred embodiment, the fine holes of the fine extrusion die has a diameter of 150, 200, 250, 300, 350, 400, 450, 500 μm, but preferably 300 to 400 μm.

In another embodiment, the present invention provides a method for manufacturing super high fluidity urethane-based spherical fine powder, the method comprising: melting and mixing a super high fluidity urethane-based thermoplastic resin at high temperature at an extruder; transferring the thermoplastic resin, molten and mixed at high temperature, to a fine extrusion die through a gear pump by a predetermined amount; controlling the temperature of the thermoplastic resin by passing coolant, supplied from a coolant tank, through a heat exchanger to be heat exchanged; passing the thermoplastic resin, transferred through the gear pump, through fine holes of the fine extrusion die to be extruded into a fine diameter and, at the same time, cutting the extruded thermoplastic resin into spherical fine powder by injecting the coolant in a underwater way from a cutting means; transferring the spherical fine powder, cut by the cutting means, together with the coolant to a centrifugal separator to be separated; and discharging the spherical fine powder, separated from the coolant, to a dehumidifying dryer to be dried.

In a preferred embodiment, the extrusion temperature of the extruder is between 90, 95, 100, to 150, 155, 160, 165 170° C., preferably 100 to 150° C. In another preferred embodiment, the temperature of the gear pump is 150 to 200° C.

In still another preferred embodiment, the temperature of the fine extrusion die is 200 to 300° C. and the temperature of the coolant injected from the cutting means is to 40° C.

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum).

As referred to herein, a hybrid vehicle is a vehicle that has two or more sources of power, for example both gasoline-powered and electric-powered.

The above features and advantages of the present invention will be apparent from or are set forth in more detail in the accompanying drawings, which are incorporated in and form a part of this specification, and the following Detailed Description, which together serve to explain by way of example the principles of the present invention.

### BRIEF DESCRIPTION OF THE DRAWINGS

The above and other features of the present invention will now be described in detail with reference to certain exemplary embodiments thereof illustrated the accompanying drawings which are given hereinbelow by way of illustration only, and thus are not limitative of the present invention, and wherein:

FIG. 1 is a schematic diagram showing an apparatus for manufacturing super high fluidity urethane-based spherical fine powder for powder slush molding in accordance with the present invention; and

FIG. 2 is a process flowchart showing a method for manufacturing spherical fine powder for powder slush molding, used as a vehicle instrument surface material, in accordance with the present invention.

Reference numerals set forth in the Drawings includes reference to the following elements as further discussed below:

| | |
|---|---|
| 10: extruder | 12: gear pump |
| 14: fine extrusion die | 16: coolant tank |
| 18: heat exchanger | 20: cutting means |
| 22: centrifugal separator | 24: transfer line |
| 26: return line | 28: discharge line |
| 30: dehumidifying dryer | |

It should be understood that the appended drawings are not necessarily to scale, presenting a somewhat simplified representation of various preferred features illustrative of the basic principles of the invention. The specific design features of the present invention as disclosed herein, including, for example, specific dimensions, orientations, locations, and shapes will be determined in part by the particular intended application and use environment.

In the figures, reference numbers refer to the same or equivalent parts of the present invention throughout the several figures of the drawing.

### DETAILED DESCRIPTION

As described herein, the present invention includes an apparatus for manufacturing a urethane-based spherical fine powder, the apparatus comprising an extruder for melting and mixing a thermoplastic resin a gear pump, a fine extrusion die, a coolant tank for supplying coolant, a heat exchanger for controlling the temperature of the coolant to a predetermined level, a transfer line, connected between the fine extrusion die and a centrifugal separator, through which the spherical fine powder, cut by the cutting means, is transferred together with the coolant, the centrifugal separator for separating the spherical fine powder and the coolant from each other, transferred through the transfer line, a coolant return line connected between the centrifugal separator and the coolant tank and collecting the coolant, a discharge line connected to the centrifugal separator and discharging the spherical fine powder, and a dehumidifying dryer.

In certain embodiments, the urethane-based spherical fine powder is a super high fluidity urethane-based spherical fine powder.

In a preferred embodiment of the method, the extruder is used for suitably melting and mixing a super high fluidity urethane-based thermoplastic resin. In a further embodiment, the thermoplastic resin transferred by the gear pump is extruded from the extruder, by a predetermined amount. In still another embodiment, the fine extrusion die includes fine holes for extruding the thermoplastic resin, transferred through the gear pump, into a fine diameter, and a cutting means for cutting the thermoplastic resin, extruded from the fine holes, into spherical fine powder in a underwater way. In further embodiments of the invention described herein the dehumidifying dryer is connected to the discharge line and dries the spherical fine powder discharged through the discharge line.

The invention also features a motor vehicle comprising the urethane-based spherical fine powder as described herein. The invention also features a motor vehicle comprising the super high fluidity urethane-based spherical fine powder as described herein.

Hereinafter reference will now be made in detail to various embodiments of the present invention, examples of which are illustrated in the accompanying drawings and described below. While the invention will be described in conjunction with exemplary embodiments, it will be understood that present description is not intended to limit the invention to those exemplary embodiments. On the contrary, the invention is intended to cover not only the exemplary embodiments, but also various alternatives, modifications, equivalents and other embodiments, which may be included within the spirit and scope of the invention as defined by the appended claims.

The present invention provides an apparatus and method for manufacturing spherical fine powder for powder slush molding using a super high fluidity urethane-based thermoplastic resin, in which the spherical fine powder is preferably capable of being used as a vehicle instrument surface material and in further preferred embodiments is used as a vehicle body material.

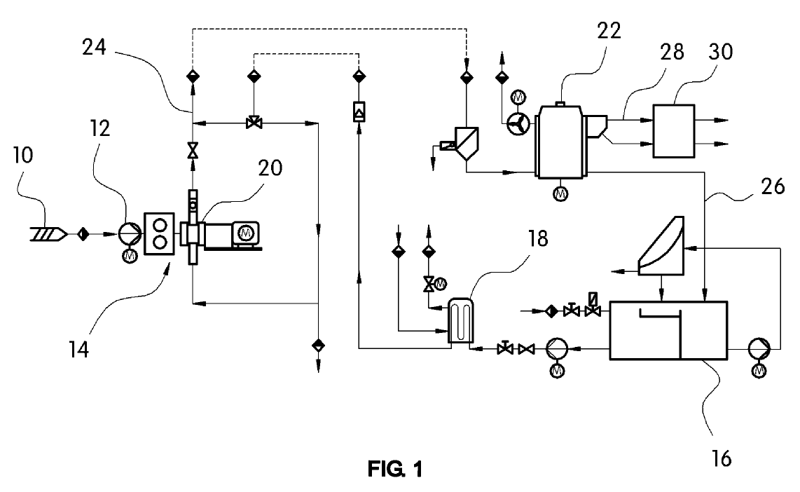

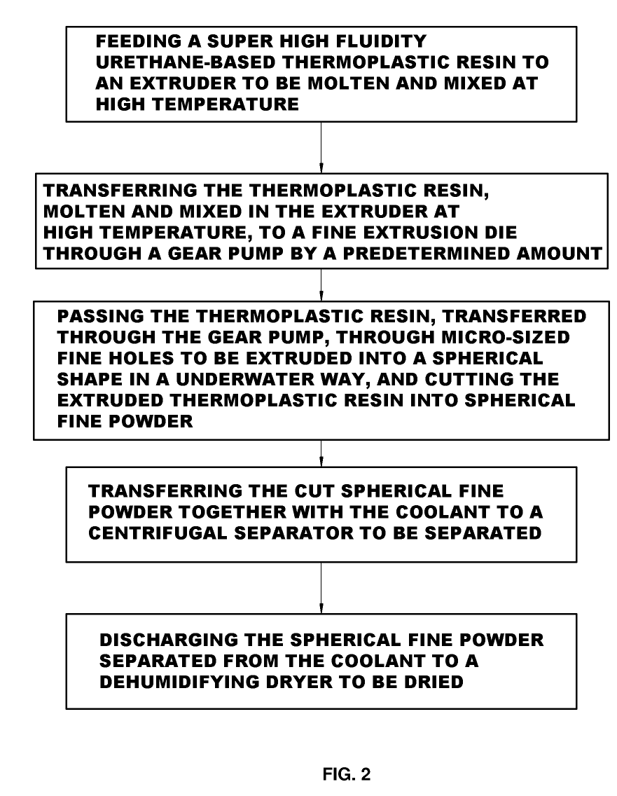

FIG. 1 is a schematic diagram showing an exemplary apparatus for manufacturing urethane-based spherical fine power, preferably super high fluidity urethane-based spherical fine powder for powder slush molding in accordance with preferred embodiments of the present invention, and FIG. 2 is a process flowchart showing an exemplary method for manufacturing spherical fine powder for powder slush molding, used as a vehicle instrument surface material, in accordance with the present invention as described herein.

According to the present invention, the super high fluidity urethane-based spherical fine powder for powder slush molding is suitably manufactured using the manufacturing apparatus, an exemplary example being shown in FIG. 1. Preferably, first, a super high fluidity urethane-based thermoplastic resin is suitably fed into an extruder 10 to be molten and mixed at a suitably high temperature. At this time, the extruder 10 may be, for example, a single-screw extruder, a twin-screw extruder or a Banbury mixer, and the twin-screw extruder is preferable in terms of mixing efficiency and productivity.

Preferably the extrusion temperature, i.e., the barrel temperature of the extruder 10, is suitably maintained in the range of 100 to 150° C., where the urethane-based thermoplastic resin, preferably the super high fluidity urethane-based thermoplastic resin is sufficiently molten and, preferably, in the range of 100 to 150, preferably, 110 to 140° C. which is suitably sufficient to melt the thermoplastic resin. If the extrusion temperature of the extruder 10 is below 100° C., it is difficult to sufficiently melt the resin, whereas, if it exceeds 150° C., energy cost is suitably increased.

Preferably, the thermoplastic resin molten and mixed in the extruder 10 is substantially uniformly transferred through a gear pump 12 to a fine extrusion die 14 by a suitably predetermined amount.

In further embodiments, in order to prevent the super high fluidity urethane-based thermoplastic resin, transferred through the gear pump 12, from being cooled, the temperature of the gear pump 12 is suitably maintained in the range of 150 to 200° C. and, preferably, in the range of 160 to 1 90° C. to prevent the molten super high fluidity urethane-based thermoplastic resin from being cooled.

Preferably, the gear pump 12 is fabricated in such a manner that two gears suitably engaged with each other are placed into a case circumscribed thereon so as to serve to transfer a predetermined amount of resin preferably through a space between grooves of gear teeth and their circumferential wall by rotating the gears at a predetermined speed. In further embodiments, if the gear pump is not used, the amount of resin transferred to the fine extrusion die 14 is not uniform and, as a result, the particle size of powder extruded from the fine extrusion die 14 and cut is not uniform.

As shown in exemplary FIG. 1, in embodiments of the invention, the thermoplastic resin preferably transferred through the gear pump 12 passes through micro-sized fine holes (not shown) of the fine extrusion die 14 such that the thermoplastic resin is extruded into a suitably fine diameter and, at the same time, cut into spherical fine powder when coolant is injected, for example, in a underwater way from a cutting means 20 provided in the fine extrusion die 14.

In further embodiments, the coolant, preferably discharged from a coolant tank 16 and then passed through a heat exchanger 18 to be heated to a predetermined temperature, is injected from the cutting means 20, for example in the underwater way, to the thermoplastic resin, passing through the fine holes of the fine extrusion die 14 and extruded into a suitably fine diameter, so that the extruded fine powder is cut into a sufficiently spherical shape.

Accordingly, in certain preferred embodiments, the diameter of the fine holes of the fine extrusion die 14 should be in the range of 250 to 500 μm, preferably, 300 to 400 μm, more preferably a little bit larger than that of the fine powder, and the temperature of the fine extrusion die 14 should be suitably maintained in the range of 200 to 300° C. to prevent the fine powder from being cooled and, preferably, in the range of 200 to 290° C., preferably 220 to 270° C.

Further, since the fine powder passing through the fine holes is preferably cut into a sufficiently spherical shape by the cutting means 20, the temperature of the coolant used at this time should preferably be maintained in the range of 10 to 40° C. so that the fine powder is cured into a spherical shape during cooling and, preferably, in the range of 10 to 30° C.

In further preferred embodiments of the invention, the coolant used in the cutting means 20 in the underwater way and the cut spherical fine powder are preferably transferred to a centrifugal separator 22 along a transfer line 24 that is preferably connected between the fine extrusion die 14 and the centrifugal separator 22 and then in still further embodiments, separated from each other, for example by the centrifugal separator 22. Preferably, the coolant is returned to the coolant tank 16 through a coolant return line 26 connected between the centrifugal separator 22 and the coolant tank 16 to be reused, and the spherical fine powder separated from the coolant is discharged through a discharge line 28, suitably connected to the centrifugal separator 22 and discharging spherical fine powder to a dehumidifying dryer 30, filtered by a mesh, dried by the dehumidifying dryer 30, which removes humidity in a vacuum state, and, in further related embodiments, then transferred to a packing bag for powder slush molding.

In certain embodiments described herein, super high fluidity urethane-based thermoplastic resin was formed into spherical fine powder in accordance with Examples of the present invention under the conditions shown in the following Table 1. The average particle size, the spherical degree of particles, and the powder fluidity for the thus formed spherical fine powder were measured and the results are shown in Table 1.

As shown in Table 1, and according to Examples 1 to 3 of the present invention, the extrusion temperature of the extruder was in the range of 100 to 1 50° C., the temperature of the gear pump was in the range of 150 to 200° C., the diameter of the fine holes of the fine extrusion die was in the range of 300 to 40o μm, the temperature of the fine extrusion die was in the range of 200 to 300° C., the temperature of the coolant was in the range of 10 to 40° C., which were all within the manufacturing conditions in accordance with the present invention. The spherical fine powder in accordance with Comparative Examples 2 and 3 was formed beyond the range in accordance with the manufacturing method of the present invention, and a product in accordance with Comparative Example 1 was formed by the conventional freeze-crushing process.

TABLE 1

| | | Gear | | Fine | | | Average | Spherical | Pinholes |
|---|---|---|---|---|---|---|---|---|---|
| | Extrusion | pump | Fine | extrusion | Coolant | Dehumidifying | particle | degree of | (by |
| Component | temp. | temp. | hole size | die temp. | temp. | dry | size | particles | moisture) |
| Example 1 | 100 | 175 | 400 | 250 | 20 | Carried out | 500 | 40 | Not |
| | | | | | | | | | present |
| Example 2 | 125 | 150 | 300 | 200 | 10 | Carried out | 520 | 35 | Not |
| | | | | | | | | | present |
| Example 3 | 150 | 200 | 400 | 300 | 40 | Carried out | 430 | 50 | Not |
| | | | | | | | | | present |
| Comparative | Freeze- | — | — | — | — | — | 250 | 180 | Not |
| Example 1 | Crushed | | | | | | | | present |
| | product | | | | | | | | |
| Comparative | 95 | 140 | 500 | 150 | 5 | Not | 820 | 170 | Present |
| Example 2 | | | | | | carried out | | | |
| Comparative | 200 | 210 | 500 | 350 | 50 | Not | 520 | 250 | Present |
| Example 3 | | | | | | carried out | | | |

[Test Method]

1. Average particle size: Obtained by measuring the average width using an Image-Pro Plus 4.0 program after observing the particles through a stereoscopic microscope (50× magnification).

Docket No.82475 (51529)

2. Spherical degree of particles: Obtained by calculating a difference between length and width measured using an Image-Pro Plus 4.0 program after observing the particles through a stereoscopic microscope (50× magnification).

3. Powder fluidity: Using an apparent specific gravity measuring apparatus of KS M 3002, after pouring 100 cc of powder into a funnel, an outlet port at the bottom of the funnel was opened and the time was recorded for all the powder to be freely dropped and flowed out of the funnel.

Taking the results of the above test, it can be seen that the spherical fine powder in accordance with Examples 1 to 3 has excellent spherical degree of particles and powder fluidity. The average particle size is somewhat larger than that of the conventional freeze-crushed product.

As described above, according to the apparatus and method for manufacturing super high fluidity urethane-based spherical fine powder in accordance with the present invention, the high manufacturing cost is reduced compared with the fine powder manufactured by the conventional freeze-crushing process, and, accordingly, it is possible to address the rear surface defects and the pinhole formation caused during the molding process of the vehicle instrument panel, and it is possible to improve the powder fluidity due to the spherical powder particles.

The invention has been described in detail with reference to preferred embodiments thereof. However, it will be appreciated by those skilled in the art that changes may be made in these embodiments without departing from the principles and spirit of the invention, the scope of which is defined in the appended claims and their equivalents.

What is claimed is:

1. An apparatus for manufacturing super high fluidity urethane-based spherical fine powder, the apparatus comprising:
an extruder for melting and mixing a super high fluidity urethane-based thermoplastic resin;
a gear pump for transferring the thermoplastic resin, extruded from the extruder, by a predetermined amount;
a fine extrusion die including fine holes for extruding the thermoplastic resin, transferred through the gear pump, into a fine diameter, and a cutting means for cutting the thermoplastic resin, extruded from the fine holes, into spherical fine powder in a underwater way;
a coolant tank for supplying coolant;
a heat exchanger for controlling the temperature of the coolant to a predetermined level;
a transfer line, connected between the fine extrusion die and a centrifugal separator, through which the spherical fine powder, cut by the cutting means, is transferred together with the coolant;
the centrifugal separator for separating the spherical fine powder and the coolant from each other, transferred through the transfer line;
a coolant return line connected between the centrifugal separator and the coolant tank and collecting the coolant;
a discharge line connected to the centrifugal separator and discharging the spherical fine powder; and
a dehumidifying dryer connected to the discharge line and drying the spherical fine powder discharged through the discharge line.

2. The apparatus of claim 1, wherein the extruder is one selected from the group consisting of a single-screw extruder, a twin-screw extruder, and a Banbury mixer.

3. The apparatus of claim 1, wherein the fine holes of the fine extrusion die has a diameter of 300 to 400 μm.

4. A method for manufacturing super high fluidity urethane-based spherical fine powder, the method comprising:
melting and mixing a super high fluidity urethane-based thermoplastic resin at high temperature at an extruder;
transferring the thermoplastic resin, molten and mixed at high temperature, to a fine extrusion die through a gear pump by a predetermined amount;
controlling the temperature of the thermoplastic resin by passing coolant, supplied from a coolant tank, through a heat exchanger to be heat exchanged;
passing the thermoplastic resin, transferred through the gear pump, through fine holes of the fine extrusion die to be extruded into a fine diameter and, at the same time, cutting the extruded thermoplastic resin into spherical fine powder by injecting the coolant in a underwater way from a cutting means;
transferring the spherical fine powder, cut by the cutting means, together with the coolant to a centrifugal separator to be separated; and
discharging the spherical fine powder, separated from the coolant, to a dehumidifying dryer to be dried.

5. The method of claim 4, wherein the extrusion temperature of the extruder is 100 to 150° C.

6. The method of claim 4, wherein the temperature of the gear pump is 150 to 200° C.

7. The method of claim 4, wherein the temperature of the fine extrusion die is 200 to 300° C. and the temperature of the coolant injected from the cutting means is 10 to 40° C.

8. The method of claim 4, the fine holes of the fine extrusion die has a diameter of 300 to 400 μm.

9. An apparatus for manufacturing a urethane-based spherical fine powder, the apparatus comprising:
an extruder for melting and mixing a thermoplastic resin;
a gear pump;
a fine extrusion die;
a coolant tank for supplying coolant;
a heat exchanger for controlling the temperature of the coolant to a predetermined level;
a transfer line, connected between the fine extrusion die and a centrifugal separator, through which the spherical fine powder, cut by the cutting means, is transferred together with the coolant;
the centrifugal separator for separating the spherical fine powder and the coolant from each other, transferred through the transfer line;
a coolant return line connected between the centrifugal separator and the coolant tank and collecting the coolant;
a discharge line connected to the centrifugal separator and discharging the spherical fine powder; and
a dehumidifying dryer.

10. The method of claim 9, where in the urethane-based spherical fine powder is a super high fluidity urethane-based spherical fine powder.

11. The apparatus for manufacturing a super high fluidity urethane-based spherical fine powder of claim 9, wherein the extruder is used for melting and mixing a super high fluidity urethane-based thermoplastic resin.

12. The apparatus for manufacturing a urethane-based spherical fine powder of claim 9, wherein the thermoplastic resin transferred by the gear pump is extruded from the extruder, by a predetermined amount.

13. The apparatus for manufacturing a urethane-based spherical fine powder of claim 9, wherein the fine extrusion die includes fine holes for extruding the thermoplastic resin, transferred through the gear pump, into a fine diameter, and a cutting means for cutting the thermoplastic resin, extruded from the fine holes, into spherical fine powder in a underwater way.

14. The apparatus for manufacturing a urethane-based spherical fine powder of claim 9, wherein the dehumidifying dryer is connected to the discharge line and dries the spherical fine powder discharged through the discharge line.

15. A motor vehicle comprising the urethane-based spherical fine powder of claim 9.

16. A motor vehicle comprising the super high fluidity urethane-based spherical fine powder of claim 1.
